(19) United States
(12) Patent Application Publication
(10) Pub. No.: US 2004/0232828 A1
(43) Pub. Date: Nov. 25, 2004

(54) Organic light-emitting device

(76) Inventors: Hiroshi Kimura, Nagano (JP); Kenya Sakurai, Nagano (JP)

Correspondence Address: ROSSI & ASSOCIATES, P.O. BOX 826, ASHBURN, VA, 20146-0826, US

(21) Appl. No.: 10/797,924

(22) Filed: Mar. 10, 2004

(30) Foreign Application Priority Data
Apr. 24, 2003 (JP) JP 2003-120560

(51) Int. Cl. H05B 33/14; H05B 33/00

(52) U.S. Cl. 313/504; 313/503; 313/506

(57) ABSTRACT

An organic EL light emitter is disclosed that can emit white light without an increase in driving voltage. The organic EL light emitter has a substrate, a reflecting electrode, and a plurality of layers comprising organic EL layers and transparent electrodes formed alternately on the reflecting electrode. The reflecting electrode is in contact with one of the organic EL layers, and each of the organic EL layers emits light of a different color. The reflecting electrode and the even numbered ones of the transparent electrodes counting from the reflecting electrode side have the same polarity as one another, while the odd numbered ones of the transparent electrodes counting from the reflecting electrode side have a polarity that is the opposite that of the reflecting electrode and the even numbered electrodes.

### BACKGROUND OF THE INVENTION

The present invention relates to an organic EL light emitter, and more specifically to an organic light-emitting device having a plurality of organic light-emitting diodes.

Organic EL display panels in which a plurality of organic light emitting diodes are arranged in a matrix, in particular organic EL display panels capable of multi-color display, are promising as the next generation of flat panel displays. Various methods of achieving full color have been studied. These include a method in which a plurality of types of organic EL light emitter that emit light of different colors are arranged on a substrate, a color conversion method in which light emitted from a backlight is subjected to wavelength distribution conversion, and a colored filter method in which light emitted from a backlight is passed through colored filters and emitted. Of these, the color conversion method and the colored filter method are thought to be advantageous with regard to making display panels that have a large area and fine pixels. With the color conversion method, it has been found that the efficiency of the color conversion is greatly improved if a backlight having a broad emission spectrum, e.g., white light, is used with color-converting filters that carry out the wavelength distribution conversion. To realize full color using the colored filter method, it is necessary for the backlight to emit white light. In order to produce a full-color organic EL display panel, an organic EL light emitter that emits white light or other light with a broad spectrum is thus required.

Many proposals have been made regarding organic EL light emitters that emit white light. For example, it has been reported that a white color can be achieved by forming light-emitting layers of two colors between an anode and a cathode (see Japanese Patent No. 3366401). Moreover, it has been reported that a white color can be achieved by arranging, between an anode and a cathode, a plurality of organic EL light-emitting units in series with equipotential surfaces therebetween (see Japanese Patent Application Laid-open No. 2003-45676).

It has been reported that by building up organic EL light emitters that emit light of the same color with the light emitters being connected together in parallel, the current density of the current flowing through the light emitters can be reduced and hence the lifetime of the light emitters can be lengthened (see Japanese Patent No. 3189438).

With all of the above methods, the light-emitting layers or light-emitting units are connected together in series in order to achieve a white color, and hence the driving voltage must be increased. An increase in the light emitter driving voltage may cause failure of the driving IC, and hence is undesirable in practice. There are thus calls for the development of an organic EL light emitter that can emit white light, and that can be driven with a low voltage.

### SUMMARY OF THE INVENTION

It is therefore an object of the present invention to provide an organic EL emitter that can achieve a white color without an undesirable increase in the driving voltage.

An organic EL light emitter of the present invention comprises a substrate, and a layered body that contains a reflecting electrode, a first organic EL layer that emits light of a first color, a first transparent electrode, a second organic EL layer that emits light of a second color different than the first color, and a second transparent electrode in this order, wherein the reflecting electrode and the second transparent electrode are of the same polarity as one another, and the first transparent electrode is of the opposite polarity thereto. The organic EL light emitter of the present invention can emit white light. Moreover, the substrate may be in contact with either the reflecting electrode or the second transparent electrode. In the case that the substrate is in contact with the second transparent electrode, the substrate is preferably a transparent substrate. Preferably, one of the first organic EL layer and the second organic EL layer emits blue/green light, and the other emits yellow light. Moreover, a light-blocking layer or a transparent insulating layer may be provided between the first transparent electrode and the second organic EL layer.

An organic EL light emitter according to the present invention also may comprise a third organic EL layer that contacts the second transparent electrode, and a third transparent electrode that contacts the third organic EL layer, wherein the third organic EL layer emits light of a color than the first color and to the second color. Moreover, it may be configured so that one of the first to third organic EL layers emits blue light, one emits green light, and one emits red light.

An organic EL light emitter of the present invention also may have a larger number of organic EL layers. Such a light emitter is characterized by having a substrate, a reflecting electrode, and a plurality of layers comprising organic EL layers and transparent electrodes formed alternately on the reflecting electrode, wherein the reflecting electrode is in contact with one of the organic EL layers, each of the organic EL layers emits light of a different color, and the reflecting electrode and the even numbered ones of the transparent electrodes counting from the reflecting electrode side have the same polarity as one another, while the odd numbered ones of the transparent electrodes counting from the reflecting electrode side have the opposite polarity thereto. Moreover, the substrate may be in contact with either the reflecting electrode, or the transparent electrode furthest from the reflecting electrode. In the case that the substrate is in contact with the transparent electrode furthest from the reflecting electrode, the substrate preferably is a transparent substrate. Moreover, a light-blocking layer or a transparent insulating layer additionally may be provided between one of the transparent electrodes and one of the organic EL layers in contact therewith.

### BRIEF DESCRIPTION OF THE DRAWINGS

FIG. 1 is a sectional view showing an example of an organic EL light emitter according to the present invention.

FIG. 2 is a sectional view showing another example of an organic EL light emitter according to the present invention.

FIG. 3 is a sectional view showing another example of an organic EL light emitter according to the present invention having a light-blocking layer.

FIG. 4 is a sectional view showing another example of an organic EL light emitter according to the present invention having resistors connected to the electrodes.

FIG. 5 is a graph showing the emission spectra of organic EL light emitters of Examples 1 and 2.

### DETAILED DESCRIPTION OF PREFERRED EMBODIMENTS

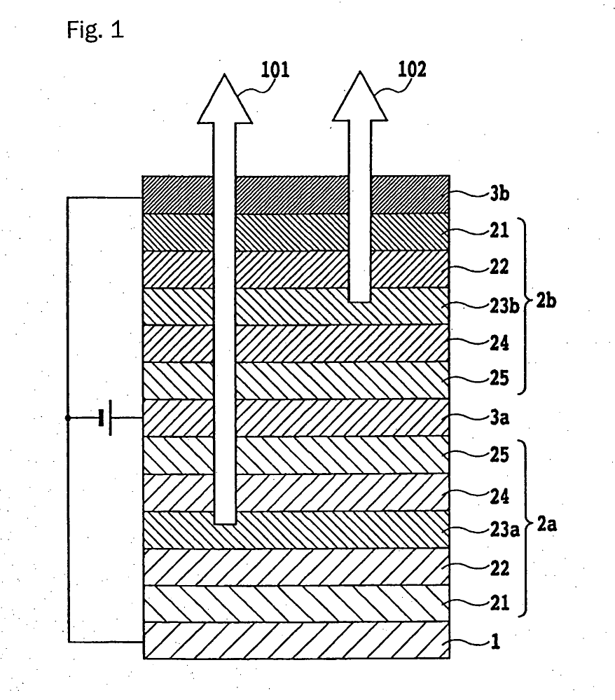

FIG. 1 shows an example of an organic EL light emitter according to the present invention. The light emitter of FIG. 1 has two light-emitting parts on a substrate (not shown). First organic EL layer 2a, first transparent electrode 3a, second organic EL layer 2b, and second transparent electrode 3b are formed on reflecting electrode 1.

Reflecting electrode 1 preferably is formed using a metal, an amorphous alloy or a microcrystalline alloy having a high reflectance. Metals having a high reflectance include Al, Ag, Mo, W, Ni, Cr and so on. Amorphous alloys having a high reflectance include NiP, NiB, CrP, CrB, and so on. Microcrystalline alloys having a high reflectance include NiAl, and so on. The reason for using reflecting electrode 1 having a high reflectance is so that light can be sent to the anode side, which is the side from which the light is emitted. Reflecting electrode 1 can be formed using any means known in the technical field in question, for example, by vapor deposition (with resistive heating or electron beam heating), sputtering, ion plating, or laser ablation.

Transparent electrodes 3 can be formed from a commercially-available material such as an electrically conductive metal oxide such as SnO₂, In₂O₃, ITO, IZO or ZnO:Al, using any means known in the technical field in question, such as vapor deposition (with resistive heating or electron beam heating), sputtering, ion plating, or laser ablation. Transparent electrodes 3 preferably have a transmissivity to light of wavelength 400 to 800 nm of at least 50%, more preferably at least 85%. Moreover, in order to improve the light emission efficiency, it is desirable for transparent electrodes 3 to have a thickness that allows for a sufficiently low resistivity, preferably a thickness of at least 30 nm, and more preferably a thickness in a range of 100 to 300 nm.

Organic EL layers 2 each contain at least organic light-emitting layer 23, and if necessary also contain one or more of electron injection layer 21, electron transport layer 22, hole transport layer 24, and hole injection layer 25. Specifically, a layer structure such as the following is adopted for each of organic EL layers 2.

(1) Organic light-emitting layer

(2) Hole injection layer/organic light-emitting layer

(3) Organic light-emitting layer/electron injection layer

(4) Hole injection layer/organic light-emitting layer/electron injection layer

(5) Hole injection layer/hole transport layer/organic light-emitting layer/electron injection layer

(6) Hole injection layer/hole transport layer/organic light-emitting layer/electron transport layer/electron injection layer

In each of the above, an electrode that acts as an anode is connected to the organic light-emitting layer or the hole injection layer, and an electrode that acts as a cathode is connected to the organic light-emitting layer or the electron injection layer.

A commercially-available material can be used as the material of organic light-emitting layer 23. For example, to obtain luminescence from blue to blue/green in color, a material such as a fluorescent whitening agent of benzothiazole type, benzimidazole type, benzoxazole type or the like, a metal chelated oxonium compound, a styrylbenzene type compound, or an aromatic dimethylidene type compound, preferably is used. Alternatively, organic light-emitting layer 23 that emits light in any of various wavelength regions may be formed by adding a dopant to a host compound. As the host compound, a distyrylarylene type compound (e.g., IDE-120 made by Idemitsu Kosan Co., Ltd., etc.), N,N′-ditolyl-N,N′-diphenyl-biphenylamine (TPD), aluminum tris-(8-quinolinolate) (Alq), or the like can be used. As the dopant, perylene (blue/purple), Coumarin 6 (blue), a quinacridone compound (blue/green to green), rubrene (yellow), 4-dicyanomethylene-2-(p-dimethylaminostyryl)-6-methyl-4H-pyran (DCM, red), a platinum octaethylporphyrin complex (PtOEP, red), and so on can be used.

As electron injection layer 21, a thin film (thickness not more than 10 nm) of an electron injecting material such as an alkali metal, an alkaline earth metal, or an alloy containing an alkali metal or an alkaline earth metal, or an alkali metal fluoride may be used. Alternatively, an aluminum quinolinol complex doped with an alkali metal or an alkaline earth metal may be used. In the present invention, in the case that transparent electrode 3 acts as an anode, it is preferable for such an electron injection layer to be provided between transparent electrode 3 and organic light-emitting layer 23, thus improving the electron injecting ability. As the material of electron transport layer 22, an oxadiazole derivative such as 2-(4-biphenyl)-5-(p-t-butylphenyl)-1,3,4-oxadiazole (PBD), a triazole derivative, a triazine derivative, a phenylquinoxaline, an aluminum quinolinol complex (e.g. Alq), or the like can be used.

As the material of hole transport layer 24, a commercially-available material such as a triarylamine type material such as TPD, N,N′-bis(1-naphthyl)-N,N′-diphenyl-biphenylamine (α-N PD), or 4,4′,4″-tris(N-3-tolyl-N-phenylamino)triphenylamine (m-MTDATA) can be used. As the material of hole injection layer 25, for example a phthalocyanine (copper phthalocyanine, etc.), or an indanthrene compound can be used.

Each of the layers in each of organic EL layers 2 can be formed using any chosen means known in the technical field in question, for example, vapor deposition (with resistive heating or electron beam heating).

In the organic EL light emitter of FIG. 1, the reflecting electrode 1 is the cathode for first organic EL layer 2a, first transparent electrode 3a is the anode for first organic EL layer 2a and second organic EL layer 2b, and second transparent electrode 3b is the cathode for second organic EL layer 2b. The materials of organic light-emitting layers 23a and 23b are selected such that the light 101 emitted by organic light-emitting layer 23a and the light 102 emitted by organic light-emitting layer 23b are different colors. For example, the light 101 can be made to be yellow light, and the light 102 can be made to be blue/green light, so that the light emitter as a whole emits white light. Note that in the present invention, ‘white light’ means light that looks white to the naked eye, i.e., light that is perceived psychologically as being white, and does not necessarily mean light that contains all of the components of the visible spectrum. The selection of the materials of the organic light-emitting layers is not limited to being such that white light is produced, but rather can be made to be such that light of any desired hue is obtained.

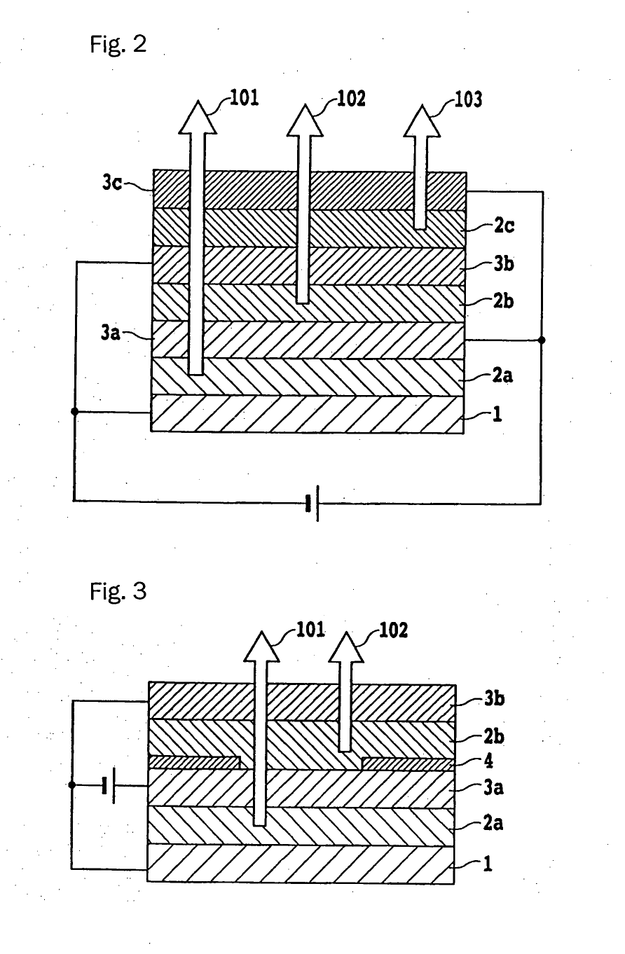

With the organic EL light emitter of the present invention, the number of organic EL layers 2 need not be limited to two. Rather, any desired number of organic EL layers 2 can be used, in order to obtain light having the desired hue. FIG. 2 shows an example of an organic EL light emitter of the present invention having three organic EL layers 2. In the light emitter of FIG. 2, first organic EL layer 2a, first transparent electrode 3a, second organic EL layer 2b, second transparent electrode 3b, third organic EL layer 2c, and third transparent electrode 3c are formed on reflecting electrode 1. Reflecting electrode 1 and second transparent electrode 3b are used as cathodes, and first and third transparent electrodes 3a and 3c are used as anodes. The order of organic EL layers 2 can be selected as desired. For example, by making first organic EL layer 2a emit light 101 that is red, making second organic EL layer 2b emit light 102 that is green, and making third organic EL layer 2c emit light 103 that is blue, white light can be obtained. In this case, again the selection of the materials of the organic light-emitting layers is not limited to being such that white light is produced, but rather can be made to be such that light of any desired hue is obtained.

An organic EL light emitter that uses more than three organic EL layers can also be formed by alternately forming organic EL layers 2 and transparent electrodes 3 on reflecting electrode 1, such that each organic EL layer 2 is sandwiched between two transparent electrodes 3 or between reflecting electrode 1 and transparent electrode 3. In such a light emitter, the reflecting electrode, and the odd numbered (first, third, etc) transparent electrodes counting from the reflecting electrode side are made to have the same polarity as each other, and the even numbered (second, fourth, etc.) transparent electrodes counting from the reflecting electrode side are made to have the opposite polarity thereto, whereby each of the organic EL layers can be made to emit light. With an organic EL light emitter that uses three or more organic EL layers, the substrate may be made to be in contact with the reflecting electrode, or may be made to be in contact with the transparent electrode positioned furthest from the reflecting electrode. In the case that the substrate is in contact with the transparent electrode positioned furthest from the reflecting electrode, it is preferable for the substrate to be a transparent substrate.

With the organic EL light emitter of the present invention, a plurality of organic EL layers emit light of different colors to one another. In the present invention, “different colors” means that the wavelength of the maximum in the optical spectrum differs. A situation in which there is overlap over part of the spectrum is not excluded. The order of forming the organic EL layers that emit light of different colors to one another can be selected as desired. It is particularly preferable to form the organic EL layers in order of the emission wavelength, with the organic EL layer having the highest emission wavelength being on the reflecting electrode side. For example, with the organic EL light emitter shown in FIG. 2, it is preferable for the selection to be carried out so that the emission wavelength of second organic EL layer 2b is shorter than that of first organic EL layer 2a, and longer than that of third organic EL layer 2c.

The organic EL light emitter of the present invention can be manufactured by forming the various constituent layers in order on a suitable substrate without releasing the vacuum. In the present invention, a top emission type organic EL light emitter in which the substrate and the reflecting electrode are made to be in contact with one another may be formed, or a bottom emission type organic EL light emitter in which the substrate and the transparent electrode furthest from the reflecting electrode are in contact with one another may be formed. As compared to manufacturing organic EL light emitters on separate substrates and then bonding these together to obtain a white light emitter, the method of the present invention reduces the manufacturing cost because additional manufacturing steps such as the bonding step are not required.

The substrate used in the present method should be able to withstand the conditions (solvents, temperature, etc.) used in the formation of the various layers, and should excellent dimensional stability. Preferable materials include metals, ceramics, glasses, and resins such as polyethylene terephthalate and polymethylmethacrylate. Alternatively, a flexible film formed from a polyolefin, an acrylic resin, a polyester resin, a polyimide resin, or the like, may be used as the substrate. The substrate may contact reflecting electrode 1, or may contact transparent electrode 3 furthest from reflecting electrode 1. In the case that the substrate contacts transparent electrode 3 furthest from reflecting electrode 1, the light emitted from the organic EL layers will be irradiated to the outside via the substrate, and hence it is preferable for the substrate to be transparent. In this case, a borosilicate glass, a blue plate glass, or the like, is particularly preferable.

With the organic EL light emitter of the present invention, the hue can be adjusted by any of various methods. An example of a method of adjusting the hue is shown in FIG. 3. The light emitter of FIG. 3 contains two organic EL layers 2a and 2b. In this light emitter, light-blocking layer 4 is provided between first transparent electrode 3a and second organic EL layer 2b, thus blocking part of the light 101 and hence changing the hue of the light emitted by the organic EL light emitter as a whole. Light-blocking layer 4 is preferably opaque over the emission wavelength region of underlying first organic EL layer 2a. Moreover, light-blocking layer 4 is preferably electrically conductive, so as not to interfere with the emission of light from second organic EL layer 2b. Light-blocking layer 4 can be formed from a metal or alloy such as Al, Ag, Mo, W, Ni, Cr, NiP, NiB, CrP, CrB or NiAl. These materials also are reflective, and hence light emitted from second organic EL layer 2b will be reflected and can thus be irradiated to the outside. This is effective in terms of improving the light emission efficiency of second organic EL layer 2b.

In order to maintain the clarity of the drawing, in FIG. 2 light-blocking layer 4 comprising two parts has been shown. However, light-blocking layer 4 can be divided into a larger number of parts distributed over the whole of first transparent electrode 3a, whereby a uniform hue can be obtained over the whole of the light-emitting surface of the organic EL light emitter. By changing the ratio of the total area of light-blocking layer 4 to the total area of first transparent electrode 3a, a desired hue can be obtained.

Alternatively, the hue of the organic EL light emitter can also be changed by disposing an insulating layer in place of light-blocking layer 4 in FIG. 2. The material of the insulating layer may be transparent or semi-transparent, but is preferably transparent. Providing such an insulating layer corresponds to reducing the surface area of first transparent electrode 3a, whereby the current flowing through second organic EL layer 2b is reduced. In contrast with the case of using light-blocking layer 4, it is thus the light 102 from second organic EL layer 2b that is reduced, whereby the hue of the organic EL light emitter can be adjusted. Transparent materials that can be used to form the insulating layer include inorganic oxides and nitrides such as SiOₓ, SiNₓ, SiNₓO_{y}, AlOₓ, TiOₓ, TaOₓ, and ZnOₓ. There are no particular limitations on the method of forming the insulating layer, with it being possible to form the insulating layer using a conventional method such as sputtering, CVD, vacuum deposition, dipping, or a sol-gel method. Note that as in the case of a light-blocking layer, it is preferable for the insulating layer to be divided into a large number of parts distributed over the whole of first transparent electrode 3a.

In an alternative embodiment, the hue is adjusted by changing the thicknesses of first organic EL layer 2a and second organic EL layer 2b. That is, by controlling the ratio of the electrical resistance to a current passing through first organic EL layer 2a and the electrical resistance to a current passing through second organic EL layer 2b, the ratio of the current flowing through first organic EL layer 2a and the current flowing through second organic EL layer 2b can be controlled, to obtain a desired hue.

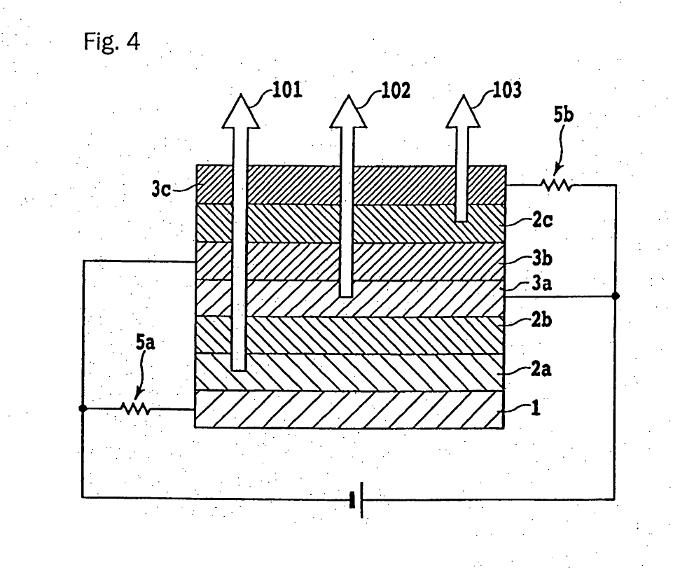

In yet another alternative embodiment, resistors are connected to reflecting electrode 1 and transparent electrodes 3. FIG. 4 shows an example of an organic EL light emitter in which the hue of the emitted light is adjusted using resistors 5. With the light emitter of FIG. 4, resistor 5a is connected to reflecting electrode 1, and resistor 5b is connected to third transparent electrode 3c. By adjusting the relative values of the resistance of the path passing through components 5a, 1, 2a and 3a, the resistance of the path passing through components 3a, 2b and 3b, and the resistance of the path passing through components 3b, 2c, 3c and 5b, the currents flowing through organic EL layers 2a to 2c can be set to desired values. Note that the electrodes to which resistors 5 are connected are of course not limited to being those shown in FIG. 4, but rather resistors 5 can be connected in positions as required to obtain the desired currents. Moreover, the adjustment methods described above have each been described taking as an example the case of using two or three organic EL layers, but these adjustment methods can also be applied to the case of using three or four or more organic EL layers.

### EXAMPLE 1

A glass substrate was disposed in a vapor deposition apparatus, and Al was deposited to a thickness of 100 nm, and then polished, to form reflecting electrode 1. Li-doped Alq (molar ratio Li:Alq=1:1) was deposited to a thickness of 5 nm as electron injection layer 21, Alq doped with rubrene (1 mass %) was deposited to a thickness of 40 nm as yellow light-emitting layer 23a, α-NPD was deposited to a thickness of 20 nm as hole transport layer 24, and copper phthalocyanine (CuPc) was deposited to a thickness of 60 nm as hole injection layer 25, to form first organic EL layer 2a. Without releasing the vacuum, the layered body was moved opposite a target in a sputtering apparatus, and IZO was formed by sputtering to a thickness of 100 nm to form first transparent electrode 3a.

The layered body was then moved back into the vapor deposition apparatus, and CuPc was deposited to a thickness of 60 nm as hole injection layer 25, (α-NPD was deposited to a thickness of 20 nm as hole transport layer 24, a distyrylarylene type compound (IDE-120 made by Idemitsu Kosan Co., Ltd.) doped with a styrylamine type dopant (DSA amine, IDE-102 made by Idemitsu Kosan Co., Ltd., 5 mass %) was deposited to a thickness of 40 nm as blue/green light-emitting layer 23b, Alq was deposited to a thickness of 20 nm as electron transport layer 22, and an MgAg alloy (molar ratio Ag:Mg=1:9) was deposited to a thickness of 5 nm as electron injection layer 21, to form second organic EL layer 2b. The layered body was then moved back into position opposite the target in the sputtering apparatus, and IZO was formed by sputtering to a thickness of 100 nm as second transparent electrode 3b.

The layered body was then removed from the sputtering apparatus, and conveyed into a glove box in which the moisture content had been controlled to 1 ppm and the oxygen content had been controlled to 1 ppm. Sealing was then carried out using a glass substrate and an ultraviolet curing type adhesive (made by Three Bond, trade name 30Y-437) having spacers of diameter 20 μm dispersed therein as an outer periphery sealing agent, to obtain an organic EL light emitter.

### EXAMPLE 2

Reflecting electrode 1, first organic EL layer 2a and first transparent electrode 3a were formed on a glass substrate as in Example 1. Next, Al was deposited to a thickness of 10 nm in the vapor deposition apparatus, thus forming light-blocking layer 4. Light-blocking layer 4 comprised a plurality of parts each having dimensions of 150 μm x 50 μm arranged so as to form a checkered pattern, and was formed so as to cover 50% of the total area of first transparent electrode 3a.

Using the same methods as in Example 1, second organic EL layer 2b and second transparent electrode 3b were formed, and then sealing was carried out, to obtain an organic EL light emitter.

### COMPARATIVE EXAMPLE 1

A glass substrate was disposed in a vapor deposition apparatus, and Al was deposited to a thickness of 100 nm. Next, without releasing the vacuum, the layered body was moved opposite a target in a sputtering apparatus, and IZO was formed by sputtering to a thickness of 100 nm, whereby a reflecting electrode comprising two layers was formed. CuPc was deposited to a thickness of 60 nm as a hole injection layer, α-NPD was deposited to a thickness of 20 nm as a hole transport layer, a distyrylarylene type compound (IDE-120 made by Idemitsu Kosan Co., Ltd.) doped with a styrylamine type dopant (DSA amine, IDE-102 made by Idemitsu Kosan Co., Ltd., 5 mass %) was deposited to a thickness of 40 nm as a blue/green light-emitting layer, Alq was deposited to a thickness of 20 nm as an electron transport layer, and an MgAg alloy (molar ratio Ag:Mg=1:9) was deposited to a thickness of 5 nm as an electron injection layer, thus forming an organic EL layer. The layered body was then moved back into position opposite the target in the sputtering apparatus, and IZO was formed by sputtering to a thickness of 100 nm as a transparent electrode. Finally, sealing was carried out as in Example 1, to obtain an organic EL light emitter having a single blue/green organic EL layer.

Evaluation

Reflecting electrode 1 and second transparent electrode 3b of the organic EL light emitter of each of Examples 1 and 2 were connected to the negative electrode of a power source, and first transparent electrode 3a was connected to the positive electrode of the power source. For the organic EL light emitter of Comparative Example 1, the reflecting electrode was connected to the positive electrode of a power source, and the transparent electrode was connected to the negative electrode of the power source. Each of the organic EL light emitters was made to emit light, and the driving voltage required to produce light with a brightness of 1600 cd/m² at a wavelength of 470 nm was measured. The driving voltage was 7V for each of Examples 1 and 2 and Comparative Example 1. This shows that with an organic EL light emitter according to the present invention, a plurality of organic EL layers can be made to emit light to give white light, without having to increase the driving voltage.

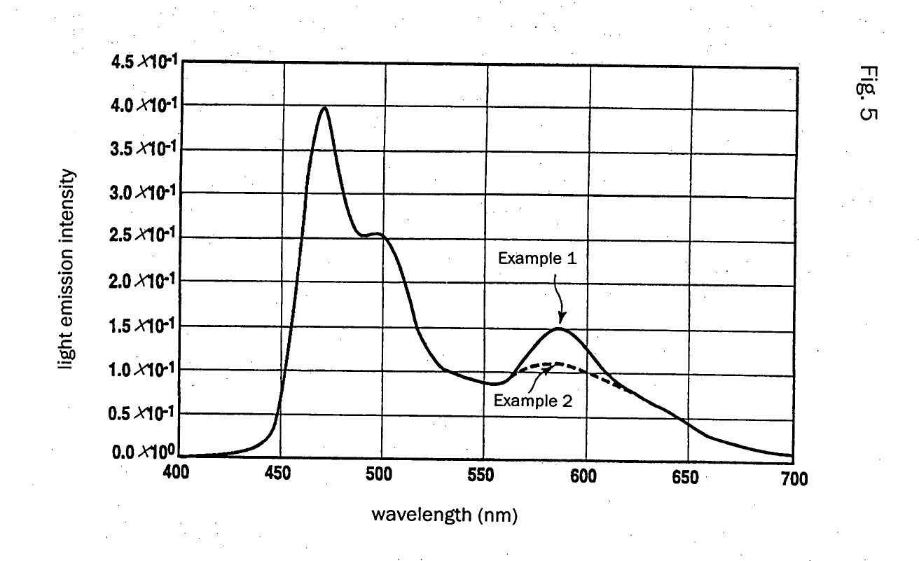

FIG. 5 shows the emission spectra of the organic EL light emitters of Examples 1 and 2. It can be seen that with the light emitter of Example 2, there is a reduction in the yellow light component from 560 to 610 nm, and hence that the hue of the light emitted by the organic EL light emitter can be adjusted using light-blocking layer 4.

### EXAMPLE 3

A glass substrate was disposed in a vapor deposition apparatus, and Al was deposited to a thickness of 100 nm, to form reflecting electrode 1. Li-doped Alq (molar ratio Li:Alq=1:1) was deposited to a thickness of 5 nm as an electron injection layer, Alq doped with IDE-106 (an amine derivative made by Idemitsu Kosan Co., Ltd., 1.2 mass %) was deposited to a thickness of 40 nm as a light-emitting layer, α-NPD was deposited to a thickness of 20 nm as a hole transport layer, and CuPc was deposited to a thickness of 60 nm as a hole injection layer, thus forming first organic EL layer 2a that emits red light. Without releasing the vacuum, the layered body was moved opposite a target in a sputtering apparatus, and IZO was formed by sputtering to a thickness of 100 nm as a first transparent electrode.

The layered body was then moved back into the vapor deposition apparatus, and CuPc was deposited to a thickness of 60 nm as a hole injection layer, α-NPD was deposited to a thickness of 20 nm as a hole transport layer, Alq doped with N,N-diethylquinacridone (0.84 mass %) was deposited to a thickness of 40 nm as a green light-emitting layer, Alq was deposited to a thickness of 20 nm as an electron transport layer, and an MgAg alloy (molar ratio Ag:Mg=1:9) was deposited to a thickness of 5 nm as an electron injection layer, to form second organic EL layer 2b that emits green light. The layered body was then moved back into the facing target sputtering apparatus, and IZO was formed by sputtering to a thickness of 100 nm as second transparent electrode 3b.

The layered body was then moved back into the vapor deposition apparatus, and Li-doped Alq (molar ratio Li:Alq=1:1) was deposited to a thickness of 5 nm as an electron injection layer, IDE-120 (made by Idemitsu Kosan Co., Ltd.) doped with IDE-105 (made by Idemitsu Kosan Co., Ltd., 1 mass %) was deposited to a thickness of 40 nm as a light-emitting layer, α-NPD was deposited to a thickness of 20 nm as a hole transport layer, and copper phthalocyanine (CuPc) was deposited to a thickness of 60 nm as a hole injection layer, thus forming a third organic EL layer 2c that emits blue light. Without releasing the vacuum, the layered body was then moved back into position opposite the target in the sputtering apparatus, and IZO was formed by sputtering to a thickness of 100 nm as third transparent electrode 3c. The layered body was then taken out of the sputtering apparatus, and sealing was carried out as in Example 1, to obtain an organic EL light emitter.

Reflecting electrode 1 and second transparent electrode 3b of the organic EL light emitter obtained were connected to the negative electrode of a power source, first transparent electrode 3a and the third transparent electrode 3c were connected to the positive electrode of the power source, and a voltage was applied, whereupon white light was obtained.

According to the present invention, an organic EL light emitter can be obtained that emits white light or light of any of various colors, without an increase in the driving voltage.

What is claimed is:

1. An organic light-emitting device comprising
a substrate, and
a layered body that contains, in order, a reflecting electrode, a first organic EL layer that emits light of a first color, a first transparent electrode, a second organic EL layer that emits light of a second color different than the first color, and a second transparent electrode,
wherein the polarity of said reflecting electrode and said second transparent electrode are the same, and the polarity of said first transparent electrode is opposite to the polarity of said reflecting electrode and said second transparent electrode.

2. The organic light-emitting device according to claim 1, which emits white light.

3. The organic light-emitting device according to claim 1, wherein said substrate and said reflecting electrode are in contact with one another.

4. The organic light-emitting device according to claim 1, wherein said substrate and said second transparent electrode are in contact with one another, and said substrate is a transparent substrate.

5. The organic light-emitting device according to claim 1, wherein each of said reflecting electrode and said second transparent electrode is an anode, and said first transparent electrode is a cathode.

6. The organic light-emitting device according to claim 1, wherein each of said reflecting electrode and said second transparent electrode is a cathode, and said first transparent electrode is an anode.

7. The organic light-emitting device according to claim 1, wherein one of said first organic EL layer and said second organic EL layer emits blue/green light, and the other emits yellow light.

8. The organic light-emitting device according to claim 1, additionally comprising a light-blocking layer between said first transparent electrode and said second organic EL layer.

9. The organic light-emitting device according to claim 1, additionally comprising a transparent insulating layer between said first transparent electrode and said second organic EL layer.

10. The organic light-emitting device according to claim 1, additionally comprising a third organic EL layer that contacts said second transparent electrode, and a third transparent electrode that contacts said third organic EL layer, wherein said third organic EL layer emits light of a color different than both the first color and the second color.

11. The organic light-emitting device according to claim 10, wherein one of said first organic EL layer, said second organic EL layer and said third organic EL layer emits blue light, one emits green light, and one emits red light.

12. An organic light-emitting device comprising
a substrate,
a reflecting electrode, and
a plurality of layers comprising organic EL layers and transparent electrodes formed alternately on said reflecting electrode,
wherein said reflecting electrode is in contact with one of said organic EL layers, each of said organic EL layers emits light of a different color, and said reflecting electrode and the even numbered ones of said transparent electrodes counting from the reflecting electrode side have the same polarity as one another, and the odd numbered ones of said transparent electrodes counting from the reflecting electrode side have the polarity opposite to that of said reflecting electrode and said even numbered ones of said transparent electrodes.

13. The organic light-emitting device according to claim 12, wherein said substrate and said reflecting electrode are in contact with one another.

14. The organic light-emitting device according to claim 12, wherein said substrate, and the one of said transparent electrodes furthest from said reflecting electrode are in contact with one another, and said substrate is a transparent substrate.

15. The organic light-emitting device according to claim 12, additionally comprising a light-blocking layer between one of said transparent electrodes and one of said organic EL layers in contact therewith.

16. The organic light-emitting device according to claim 12, additionally comprising a transparent insulating layer between one of said transparent electrodes and one of said organic EL layers in contact therewith.
